(19) United States
(12) Patent Application Publication
(10) Pub. No.: US 2020/0091472 A1
(43) Pub. Date: Mar. 19, 2020

(54) FLAME-RETARDED ELASTIC POLYURETHANE FOAM, ADHESIVE TAPE WITH A CARRIER MADE THEREFROM, AND PRODUCTION METHOD THEREFOR

(71) Applicant: tesa SE, Norderstedt (DE)

(72) Inventors: Vanessa HOMANN, Hamburg (DE); Jacob BELARDI, Hamburg (DE); Ediz EROL, Hamburg (DE)

(73) Assignee: tesa SE, Norderstedt (DE)

(21) Appl. No.: 16/570,241

(22) Filed: Sep. 13, 2019

(30) Foreign Application Priority Data
Sep. 14, 2018 (DE) 10 2018 215 651.4

(51) Int. Cl. H01M 2/08; C08J 9/28; C09J 7/26; C09J 7/38; C09J 5/00

(52) U.S. Cl. CPC H01M 2/08; C08J 9/286; C09J 7/26; C09J 7/385; C09J 5/00; C09J 2433/00; C08J 2375/06; C08J 2375/08; C08J 2375/14; C09J 2203/33; C09J 2475/006; C08J 2201/028

(57) ABSTRACT

Systems and methods provide a polyurethane foam. One method may obtainable the polyurethane foam by mechanical foaming with a starting mixture comprising a polyurethane dispersion, the polyurethane being composed of at least one polyisocyanate component and at least one polyol component, and at least one surfactant. The polyol component or at least one of the polyol components may comprise at least one comonomer having flame retardancy effect and containing two hydroxyl groups. The adhesive tapes produced therefrom may adhesively bond components in vehicles, aircraft or trains, or in electronic devices.

This application claims foreign priority benefit under 35 U.S.C. § 119 of German Application No. 10 2018 215 651.4 filed Sep. 14, 2018.

The present invention relates to a polyurethane foam obtainable by mechanical foaming of a starting mixture comprising a polyurethane dispersion, the polyurethane being composed of, i.e. having been produced from, at least one polyisocyanate component and at least one polyol component, and comprising at least one surfactant. The invention further relates to an adhesive tape with a polyurethane foam of this kind as carrier, to the use of the polyurethane foam and also of the adhesive tape, and to a method for producing the polyurethane foam.

Adhesives and adhesive tapes are generally used to assemble two substrates so as to form a durable or permanent bond. In spite of there being a multiplicity of adhesives and adhesive tapes, innovative substrates and also rising requirements with regard to the end use are necessitating the development of new pressure-sensitive adhesive compositions (i.e. self-adhesive compositions), formulations and adhesive-tape designs. One important property which has emerged is that of flame retardancy.

Hence there are a multitude of applications and constructions where materials used are subjected by the legislator to exacting requirements in terms of their low flammability. Adhesives and adhesive tapes which are of low flammability are therefore employed primarily in constructions which are subject to such heightened safety requirements. Such constructions are found in sectors including that of transport, such as in aircraft, trains, buses and other vehicles, for example, and also elevators. In buildings as well, especially those accessible to the public, a frequent requirement is to equip adhesive tapes used therein in such a way that they are of low flammability or are completely non-flammable. Another example is computer technology, where progressive miniaturization of components is increasingly dictating the use of pressure-sensitive adhesive tapes, while at the same time the requirements imposed on these tapes are becoming ever greater. Very high temperatures may occur in the circuits simply in operation. Where soldered connections are produced on the circuits as well, temperatures of 280° C. or more occur, and adhesive tapes present must not ignite at such temperatures.

The concepts of “flame retardancy” and “low flammability” frequently also encompass indirect aspects in addition, such as reduced evolution of smoke and of heat, and also the prevention or at least diminishment of the formation of harmful gases.

Besides flame-retarded adhesive compositions, the carriers of such adhesive tapes must also have flame-retarded properties. For the stated areas of application specifically, however, there are further requirements imposed on the adhesive tapes and/or their carriers. For instance, there is a particular need for foamed carriers.

Flame-retarded foams are indeed known. For instance, flame retardants are added as a further component to polyurethane dispersions and are foamed together with the dispersion. A problem with such foams is that they experience migration of the additized flame retardants, meaning that the additives migrate within a layer or into an adjacent layer and it is therefore not possible to ensure a uniform flame retardancy effect across the whole of the foam.

In order to eliminate this problem of migration, WO 03/042272 A1 proposes that the polyurethanes have copolymers with flame retardancy effect “built into them”. The flame-retarding effect therefore originates from building blocks of the polyurethane, and so there is no migration. Flame retardancy components employed in this case include, in particular, components containing halogen or containing phosphorus.

US 2010/0152374 A1 as well describes polyurethanes with copolymers having flame retardancy effect for use in coatings, adhesive compositions or seals. Here, polyphosphate esters are reacted with a diisocyanate component and also with a polyol component.

The foams stated in the two published specifications constitute rigid foams.

In the area of the specific adhesive bonding applications, however, not all polyurethanes/polyurethane foams are suitable. For many applications, for instance, there is a need in particular for elastic polyurethane foams. The polyurethanes stated above are therefore not suitable.

EP 2 860 028 A1 describes polyurethane foams with particular suitability as a seal or adhesive tape, with thicknesses not greater than 0.2 mm. These foams are obtained by “frothing”, i.e. mechanical beating or foaming of polyurethane dispersions. These foams, however, do not have flame-retarding properties.

A particular challenge in relation to flame retardancy properties in adhesive tapes with carriers is that even if both carrier and adhesive composition(s) each per se have good flame retardancy properties, this is not necessarily so for the combination of carrier and adhesive composition. It is always necessary to check to what extent the combination of adhesive composition and carrier fulfils the flame retardancy requirements.

It is an object of the invention, therefore, to provide a polyurethane foam which has good flame retardancy properties, in particular exhibiting no flame retardant migration, and which is suitable as a carrier for adhesive tapes.

This object is achieved by a polyurethane foam as described in the main claim. The dependent claims provide advantageous developments of the subject matter of the invention. Furthermore, the invention embraces an adhesive tape with the polyurethane foam as carrier, the use of the polyurethane foam and also of the adhesive tape, and a method for producing the polyurethane foam.

The invention relates accordingly to a polyurethane foam of the type specified at the outset, in which the polyol component or at least one of the polyol components comprises at least one comonomer having flame retardancy effect and containing two hydroxyl groups.

A polyol component in the sense of the invention refers not only to polymers having at least two hydroxyl groups but also, generally, to compounds having at least two hydrogen atoms that are active toward isocyanates.

Surprisingly it has emerged in the context of the invention that mechanical foaming, also referred to as frothing or beating, of mixtures according to the invention, comprising at least polyurethane dispersion and surfactant, produces elastic foams which exhibit good flame retardancy properties and are therefore also suitable as carriers for flame-retarded adhesive tapes, especially those with acrylate adhesive compositions. Also encompassed by a mixture according to the invention is a polyurethane dispersion which from the outset already includes sufficient amounts of surfactant, so that no further addition of surfactant is necessary ahead of frothing.

A polyurethane dispersion in this context refers not only to completed polyurethane dispersions but also to polyurethane prepolymers which in the course of the beating react to form the polyurethane in foam form.

As polyurethane dispersions in the context of the present invention it is possible to employ the following dispersions, optionally in combination:

a) anionically stabilized aliphatic polyester polyurethane dispersions (dispersions based on polyester and aliphatic anionic isocyanate-polyurethane). These include the following products sold by Covestro AG: Impranil® LP RSC 1380, DL 1537 XP, DL 1554 XP.
b) Anionically stabilized aliphatic polyether-polyurethane dispersions. These include the following products sold by Covestro AG: Impranil® LP DSB 1069.
c) Anionically stabilized aliphatic polycarbonate-polyester-polyurethane dispersions. These include the following products sold by Covestro AG: Impranil® DLU.
d) Anionically stabilized polycarbonate-polyurethane dispersions. These include the following products sold by Covestro AG: Impranil® DL 2288 XP.

These are polyurethane dispersions having a high solids fraction (approximately 30 to 70 wt %, preferably 50 to 60 wt %). All products identified above under a) to d) are free from organic co-solvents, thickeners and external surfactants.

The polyurethane dispersions of the present invention are aqueous. Preferably they are free from organic solvents, but may optionally include organic solvents.

The at least one polyisocyanate component is preferably a diisocyanate. Use may be made of aromatic diisocyanates such as toluene diisocyanate (TDI) (with particular preference), p-phenylene diisocyanate (PPDI), 4,4′-diphenylmethane diisocyanate (MDI), p,p′-bisphenyl diisocyanate (BPDI), or, in particular, aliphatic diisocyanates, such as isophorone diisocyanate (IPDI), 1,6-hexamethylene diisocyanate (HDI), or 4,4′-diisocyanatodicyclohexylmethane (H12MDI). Also suitable are diisocyanates with substituents in the form of halo-, nitro-, cyano-, alkyl-, alkoxy-, haloalkyl-, hydroxyl-, carboxyl-, amido-, amino- or combinations thereof.

All in all it is possible to employ all aliphatic, cycloaliphatic, araliphatic and, preferably, the aromatic polyfunctional isocyanates which are known per se.

Specific examples include the following: alkylene diisocyanates having 4 to 12 carbon atoms in the alkylene radical, such as dodecane 1,12-diisocyanate, 2-ethyltetra-methylene 1,4-diisocyanate, 2-methylpentam ethylene 1,5-diisocyanate, tetramethylene 1,4-diisocyanate, and preferably hexamethylene 1,6-diisocyanate; cycloaliphatic diisocyanates such as cyclohexane 1,3-diisocyanate and cyclohexane 1,4-diisocyanate and any desired mixtures of these isomers, 1-isocyanato-3,3,5-trimethyl-5-isocyanatomethylcyclohexane (isophorone diisocyanate), hexahydrotolylene 2,4- and 2,6-diisocyanate and any desired mixtures of these isomers, dicyclohexylmethane 4,4′-, 2,4′- and 2,2′-diisocyanate and any desired mixtures of these isomers, and, preferably, aromatic di- and polyisocyanates, such as, for example, tolylene 2,4- and 2,6-diisocyanate and the corresponding isomer mixtures, diphenylmethane 4,4′-, 2,4′- and 2,2′-diisocyanate and the corresponding isomer mixtures, mixtures of diphenylmethane 4,4′- and 2,4′-diisocyanates, polyphenylpolymethylene polyisocyanates, mixtures of diphenylmethane 4,4′-, 2,4′- and 2,2′-diisocyanates and polyphenylpolymethylene polyisocyanates (polymeric MDI), and mixtures of polymeric MDI and tolylene diisocyanates. The organic di- and polyisocyanates may be used individually or in the form of their mixtures.

The polyisocyanate component preferably has a number-average molecular weight of 60 to 50 000 g/mol, more particularly of 400 to 10 000 g/mol, more preferably of 400 to 6000 g/mol.

Also frequently used are what are called modified polyfunctional isocyanates, these being products which are obtained by chemical reaction of organic di- and/or polyisocyanates. Examples include di- and/or polyisocyanates containing ester, urea, biuret, allophanate, carbodiimide, isocyanurate, uretdione and/or urethane groups. Specific examples contemplated are as follows: urethane-group-containing organic, preferably aromatic, polyisocyanates having NCO contents of 33.6 to 15 wt %, preferably of 31 to 21 wt %, based on the total weight. Examples are 2,4- and/or 2,6-tolylene diisocyanate or polymeric MDI modified with low molecular diols, triols, dialkylene glycols, trialkylene glycols or polyoxyalkylene glycols having number-average molecular weights of up to 6000 g/mol, more particularly up to 1500 g/mol. Examples of suitable di- and/or polyoxyalkylene glycols are diethylene, dipropylene, polyoxyethylene, polyoxypropylene and polyoxypropylene-polyoxyethylene glycols, triols and/or tetrols. Also suitable are prepolymers containing NCO groups, with NCO contents of 25 to 3.5 wt %, preferably of 21 to 14 wt %, based on the total weight, prepared from polyester polyols and/or preferably polyether polyols and 4,4′-diphenylmethane diisocyanate, mixtures of 2,4′- and 4,4′-diphenylmethane diisocyanate, 2,4- and/or 2,6-tolylene diisocyanate or polymeric MDI. Having also been found appropriate are liquid polyisocyanates containing carbodiimide groups and/or isocyanurate rings, having NCO contents of 33.6 to 15 wt %, preferably 31 to 21 wt %, based on the total weight, on the basis, for example, of 4,4′-, 2,4′- and/or 2,2′-diphenylmethane diisocyanate and/or 2,4- and/or 2,6-tolylene diisocyanate.

The modified polyisocyanates may be mixed with one another or with unmodified organic polyisocyanates such as, for example, 2,4′-, 4,4′-diphenylmethane diisocyanate, polymeric MDI, 2,4- and/or 2,6-tolylene diisocyanate.

Having been found particularly appropriate as isocyanates are diphenylmethane diisocyanate isomer mixtures or polymeric MDI, and more particularly polymeric MDI having a diphenylmethane diisocyanate isomer content of 30 to 55 wt %, and also polyisocyanate mixtures containing urethane groups and based on diphenylmethane diisocyanate, with an NCO content of 15 to 33 wt %.

Preferred weight fractions of the polyisocyanate component are from 10 to 40 wt %, more particularly 13 to 35 wt %, and very preferably 15 to 30 wt %.

As noted above, the term “polyol component” in the sense of the invention refers not only to polymers having at least two hydroxyl groups but also, generally, to compounds having at least two hydrogen atoms that are active toward isocyanates.

The polyol component is preferably a diol, a polyether diol, a polyester diol, a polycarbonate diol, a polycaprolactone polyol or a polyacrylate polyol, particular preference being given to polyether diol, polyester diol and polycarbonate diol, more particularly glycol, propanediol, butanediol, pentanediol, hexanediol, cyclohexanediol, cyclohexyldimethanol, octanediol, neopentyl glycol, diethylene glycol, triethylene glycol, trimethylpentanediol, benzenedimethanol, benzenediol, methylbenzenediol, bisphenol A, poly(butanediol-co-adipate) glycol, poly(hexanediol-co-adipate) glycol, poly(ethanediol-co-adipate) glycol, polytetramethylene glycol, polypropylene glycol, polyethylene glycol, or a mixture thereof.

The principal function of the polyol component is to react with the polyisocyanate component to form the polyurethane polymer. Additionally, however, the polyol component also serves as a physical conditioner, since the elasticity of the polyurethane is dependent on the molecular weight of the polyol component. Generally it is the case that the higher the molecular weight of the polyol component, the more flexible the resulting polyurethane.

The polyol component preferably has a number-average molecular weight of 60 to 50 000 g/mol, more particularly of 400 to 10 000 g/mol, more preferably of 400 to 6000 g/mol.

The at least one building block, i.e. comonomer, having flame retardancy effect may preferably be a halogen-containing building block, more particularly selected from the group consisting of derivatives of tetrabromophthalic acid, modified 2,3-dibromo-2-butene-1,4-diols, tris(2-chloroisopropyl) phosphate, tetrabromobisphenol A or mixtures thereof.

With particular preference the at least one building block, i.e. comonomer, having flame retardancy effect is a phosphorus-containing building block, more particularly selected from the group consisting of hydroxyl-functionalized alkyl phosphates, especially hydroxyl-functionalized tributyl phosphate, hydroxyl-functionalized triphenyl phosphate, hydroxyl-functionalized triethyl phosphate, hydroxyl-functionalized arylphosphates, especially hydroxyl-functionalized diphenyl cresyl phosphate, hydroxyl-functionalized halogenated alkyl phosphates, especially hydroxyl-functionalized tris(2-chloroisopropyl) phosphate, or a phosphate ester of the general formula

HO—(POOR₁—O—R₂—O)ₙ—POOR₁—OH

where R₁=alkyl or alkoxy, R₂=alkyl radical with C₁ to C₆, and 2≤n≤300, or mixtures thereof. The phosphate ester of the formula indicated above is particularly suitable on account of its environmental compatibility, since in contrast to conventional halogen-based flame retardants and even at high flame temperatures it burns only in such a way as to form non-toxic gases and with little evolution of smoke.

Preferred amounts of the at least one building block, i.e. comonomer, having flame retardancy effect are from 1 to 50 wt %, preferably 5 to 30 wt % and more particularly 7 to 20 wt %.

To set the properties of the polyurethane foam it may be advantageous for the starting mixture to further comprise at least one further dispersion, typically selected from the group consisting of polyurethane dispersions whose polyol component includes no comonomer having flame retardancy effect, polyurethane dispersions whose polyol component includes a comonomer having flame retardancy effect, synthetic rubber dispersions, natural rubber dispersions and polyacrylate dispersions. In this way it is possible to set properties including the stability of the polyurethane foam and its elongation at break.

Polyacrylate dispersions comprise water-insoluble polyacrylate, which typically is present in emulsifier-mediated dispersion in water. They contain, for example, about 30 to 60 wt % of polyacrylate and about 3 wt % of emulsifier. The polyacrylate, in accordance with the invention, is a water-insoluble polyacrylate, polymethacrylate, mixtures thereof or copolymers with other monomers. The emulsifier may be an ionic, nonionic or steric emulsifier. It is normally not fixedly incorporated into the polymer chains. Acrylate dispersions may comprise further additives, such as film-formers or co-solvents, defoamers, flame retardants and/or wetting agents.

Acrylate dispersions are typically obtained by the emulsion polymerization of suitable monomers. For this purpose, these monomers are finely dispersed in water by means of an emulsifier. The emulsion of the monomers in water is admixed with a water-soluble radical initiator. Because the radicals formed from this initiator dissolve preferentially in the water, their concentration in the monomer droplets is low, and hence the polymerization is able to proceed very uniformly in these droplets. After the end of the polymerization, the dispersion can be used directly; often, however, it is admixed with additives such as defoamers, film-formers and/or wetting agents, in order to bring about further improvement in the properties.

The reaction of the OH groups of the polyol component with the isocyanate groups may optionally be catalysed. The following in particular are contemplated as the catalyst:

Organometallic compounds, preferably organotin compounds, such as tin(II) salts of organic carboxylic acids, for example tin(II) acetate, tin(II) octoate, tin(II) ethylhexanoate, tin(II) laurate and the dialkyltin(IV) salts of organic carboxylic acids, for example dibutyltin diacetate, dibutyltin dilaurate, dibutyltin maleate, dioctyltin diacetate, and also tertiary amines such as triethylamine, tributylamine, dimethylcyclohexylamine, dimethylbenzylamine, N-methylimidazole, N-methyl-, N-ethyl-, N-cyclohexyl-morpholine, N,N,N′,N′-tetramethylethylenediamine, N,N,N′,N′-tetramethylbutylene-diamine, N,N,N′,N′-tetramethylhexylene-1,6-diamine, pentamethyldiethylenetriamine, tetramethyldiaminoethyl ether, bis(dimethylaminopropyl)urea, dimethylpiperazine, 1,2-dimethylimidazole, 1-azabicyclo[3.3.0]octane, 1,4-diazabicyclo[2.2.2]octane, and also alkanolamine compounds such as triethanolamine, trisisopropanolamine, N-methyl- and N-ethyldiethanolamine and dimethylethanolamine.

Further catalysts contemplated include the following: tris(dialkylamino)-s-hexahydrotriazines, especially tris(N,N-dimethylamino)-s-hexahydrotriazine, tetraalkylammonium salts such as, for example, N,N,N-trimethyl-N-(2-hydroxypropyl) formate, N,N,N-trimethyl-N-(2-hydroxypropyl) 2-ethylhexanoate, tetraalkylammonium hydroxides such as tetramethylammonium hydroxide, alkali metal hydroxides such as sodium hydroxide, alkali metal alkoxides such as sodium methoxide and potassium isopropoxide, and also alkali metal or alkaline earth metal salts of fatty acids having 1 to 20 carbon atoms and optionally pendent OH groups.

Preference is given to using tertiary amines, compounds of tin and of bismuth, alkali metal and alkaline earth metal carboxylates, quaternary ammonium salts, s-hexa-hydrotriazines and tris(dialkylaminomethyl)phenols.

Use is made preferably of 0.001 to 5 wt %, more particularly 0.002 to 2 wt %, of catalyst or catalyst combination, based on the total weight of the starting mixture.

The polyurethane may optionally comprise a component containing active hydrogen and being able to form a hydrophilic group, preferably at from 1 to 15 wt %, more particularly from 3 to 10 wt % and very preferably from 4 to 7 wt %. “Active hydrogen” here means that the hydrogen atom of the component has an instability allowing it to undergo a chemical reaction—a substitution reaction, for example—easily with other compounds, so that a hydrophilic group can be formed. The effect of this component is that the polyurethane can be dispersed efficiently in water. A suitable hydrophilic group in particular is as follows: —COO⁻, —SO₃⁻, —NR₃⁺, or —(CH₂CH₂O)ₙ—. The component comprising active hydrogen may be, for example, as follows: dimethylolpropionic acid (DMPA), dimethylolbutyric acid (DMBA), poly(ethylene oxide) glycol, bis(hydroxyethyl)amines, or sodium 3-bis(hydroxyethyl)amino-propanesulfonate.

As described above, the component comprising active hydrogen is optional. For the purpose of dispersion, the polyurethane dispersion alternatively or additionally frequently comprises at least one surfactant.

As particularly suitable surfactants, also acting as foam stabilizer, particular mention may be made of Stokal® STA (ammonium stearate) and Stokal® SR (succinamate) from the Bozzetto group.

Also contemplated, however, are further surfactants, which in particular may be selected from the group consisting of ether sulfates, fatty alcohol sulfates, sarcosinates, organic amine oxides, sulfonates, betaines, amides of organic acids, sulfosuccinates, sulfonic acids, alkanolamides, ethoxylated fatty alcohols, sorbates and combinations thereof.

As a further optional component, the starting mixture may comprise a thickener. Here it is possible for example to use Borchigel® ALA. Also suitable as thickeners are polyetherurethane solutions such as Ortegol PV301 from Evonik Industries, for example. A thickener ensures that the polyurethane foam also remains stable on drying.

Likewise optionally, the starting mixture may comprise a crosslinker. Suitable such include, in particular, melamine-based crosslinkers such as melamine, and isocyanate-based or polyaziridine-based crosslinkers. Also particularly suitable are water-based blocked aliphatic polyisocyanates, which are deblocked at elevated temperatures with release of the isocyanate groups. After cooling, the isocyanate groups react with atmospheric moisture. This produces amino groups, which then react with the isocyanate groups to form urea groups (i.e., reaction with themselves). Generally speaking it is also conceivable for deblocked isocyanates to react with OH groups of the polyurethane (to form further urethane groups). One example of such a crosslinker is Imprafix 2794 from Covestro AG. A further possible crosslinker is Cymel® 325.

The starting mixture may comprise further additives such as light stabilizers or other stabilizers. Solvents can be added as further additives as well, in which case the fraction of the solvent may be up to 50 wt %, based on the total amount of the completed starting mixture. Suitable solvents are those customary for the production of polyurethane materials, such as low-boiling hydrocarbons having boiling points below 100° C., preferably below 50° C., but also other solvents such as, for example, paraffins, halogenated hydrocarbons, halogenated paraffins, ethers, ketones, alkyl esters of carboxylic acids, alkyl carbonates, or additional liquid flame retardants such as alkyl phosphates, as for example triethyl phosphate or tributyl phosphate, halogenated alkyl phosphates, as for example tris(2-chloropropyl) phosphate or tris(1,3-dichloropropyl) phosphate, aryl phosphates as for example diphenyl cresyl phosphate, phosphonates as for example diethyl ethanephosphonate. It is likewise possible to employ mixtures of the stated solvents and/or additional flame retardants.

Other optional additives are cell regulators of the conventional kind such as paraffins or fatty alcohols or dimethylpolysiloxanes, flame retardants, pigments or dyes, stabilizers against effects of ageing and weathering, plasticizers, substances with fungistatic and bacteriostatic activity, fillers such as barium sulfate, bentonite, kaolin, glass powders, glass beads, glass fibres, calcium carbonate, kieselguhr, silica sand, fluoropolymers, thermoplastics, microspheres, expandable graphite, carbon black or precipitated chalk, or combinations thereof.

The present invention also embraces a method for producing the polyurethane foam of the invention, having the following steps:
a) initially introducing the components, namely a polyurethane dispersion, the polyurethane being composed of at least one polyisocyanate component, at least one polyol component comprising at least one comonomer having flame retardancy effect and containing two hydroxyl groups, and optionally further polyol components, and at least one surfactant, and also, optionally, further components, namely
   i) further dispersions comprising polyurethane or polyacrylate, to form a starting mixture;
b) mechanically foaming the starting mixture to form a wet polyurethane foam composition, optionally with addition of further components, namely
   ii) crosslinkers,
   iii) fillers and/or
   iv) further additives;
c) applying the wet polyurethane foam composition to a surface;
d) drying the wet polyurethane foam composition to give the polyurethane foam.

The polyurethane dispersion may be produced here in the manner described hereinafter.

The at least one comonomer having flame retardancy effect and the at least one polyol component, and also, optionally, the component containing active hydrogen, and also solvents (e.g. acetone or N-methylpyrrolidone), are introduced into a container under a nitrogen atmosphere and stirred with—for example—a paddle stirrer. When the components are thoroughly mixed, the at least one polyisocyanate component is added and the container is heated to approximately 40 to 90° C. for four to six hours and then cooled.

When the container has cooled to 30° C. to 50° C., a basic solution such as triethylamine, for example, is added with stirring and the mixture is neutralized for fifteen to twenty minutes. The mixture is then introduced into water; at this point, optionally, a chain extender can be added. This gives the polyurethane dispersion of the invention with flame retardancy effect.

In order to form the polyurethane foam, the starting mixture, in other words the polyurethane dispersion produced as above or otherwise, together with the at least one surfactant, and also, optionally, with a solvent, with a crosslinker and/or with the further optional constituents, is mechanically beaten and foamed. Optionally it is possible for a thickener to be added after the beating.

Alternatively, a polyurethane dispersion is not initially produced. Instead, a prepolymer dispersion is employed, and the prepolymer polymerizes during the mechanical beating/foaming to form the polyurethane.

It is possible, though not necessary, to add a physical blowing agent as well. Hence the starting mixture may be foamed, for example, in the presence of a gas such as air or nitrogen or of a noble gas such as, for example, helium, neon or argon.

Blowing agents may be employed individually or as a mixture of different blowing agents. Blowing agents may be selected from a large number of materials, including the following: hydrocarbons, ethers and esters and the like. Typical physical blowing agents have a boiling point in the range from −50° C. to +100° C., and preferably from −50° C. to +50° C. Preferred physical blowing agents include the HCFCs (hydrofluorochlorocarbons) such as 1,1-dichloro-1-fluoroethane, 1,1-dichloro-2,2,2-trifluoroethane, monochlorodifluoromethane and 1-chloro-1,1-difluoroethane; the HFCs (hydrofluorocarbons) such as 1,1,1,3,3,3-hexafluoropropane, 2,2,4,4-tetrafluorobutane, 1,1,1,3,3,3-hexafluoro-2-methylpropane, 1,1,1,3,3-pentafluoropropane, 1,1,1,2,2-pentafluoropropane, 1,1,1,2,3-pentafluoropropane, 1,1,2,3,3-pentafluoropropane, 1,1,2,2,3-pentafluoropropane, 1,1,1,3,3,4-hexafluorobutane, 1,1,1,3,3-pentafluorobutane, 1,1,1,4,4,4-hexafluorobutane, 1,1,1,4,4-pentafluorobutane, 1,1,2,2,3,3-hexafluoropropane, 1,1,1,2,3,3-hexafluoropropane, 1,1-difluoroethane, 1,1,1,2-tetrafluoroethane, and pentafluoroethane; fluoroethers such as methyl 1,1,1-trifluoroethyl ether and difluoromethyl 1,1,1-trifluoroethyl ether; hydrocarbons such as n-pentane, isopentane, and cyclopentane; methylene chloride; or any desired combinations of the aforesaid compounds. Such blowing agents may be used preferably in amounts of 5 wt % to 50 wt % of the reaction mixture, more particularly of 10 wt % to 30 wt % of the reaction mixture.

The resultant foam preferably has a density of 250 kg/m³ to 500 kg/m³, more preferably 350 to 450 kg/m³.

As a result of the foaming, and depending on the components used, the foam has a certain viscosity. The latter is preferably at most 18 Pa·s, more particularly at most 15 Pa·s, more preferably at most 12 Pa·s, more particularly at most 9 Pa·s, very preferably at most 8 Pa·s, more particularly at most 7 Pa·s, especially preferably at most 6 Pa·s, more particularly at most 5 Pa·s. Moreover, the foam preferably has a viscosity of at least 0.8 Pa·s, more particularly at least 0.9 Pa·s, more preferably at least 1 Pa·s, more particularly at least 1.5 Pa·s, very preferably at least 2 Pa·s, more particularly at least 2.5 Pa·s, especially preferably at least 3 Pa·s, more particularly at least 3.5 Pa·s, or at least 4 Pa·s.

The foam obtained may preferably be further-processed and dried. In this case the foam is applied in the form of a foam layer to a carrier. On the carrier, the foam is dried. This may be done, for example, in a drying oven. The foam may be moved through the drying oven on the carrier, for example.

The carrier may be a release liner, a permanent liner, or a temporary carrier with a non-adhesive surface. The carrier may in particular have been coated with an anti-stick agent such as a silicone coating or may comprise a non-stick material such as, for example, a fluoropolymer, e.g. Teflon®.

Optionally a film may be applied over the foam layer. The film, if stretched, may limit the thickness of the foam layer. Alternatively the film may function only as a covering.

In a further preferred embodiment, the foam may be applied to the carrier by means of a blade or a knife, so producing a uniform thickness on the part of the foam layer before it is brought or moved into the drying oven. Alternatively there may also be rollers provided for setting the thickness of the foam layer.

Application of the foam layer to the carrier and optional covering with a film are followed by drying, preferably in a drying oven, which promotes crosslinking. Preferred temperatures for drying are from 50° C. to 180° C., preferably from 50° C. to 120° C., more particularly from 70° C. to 115° C., especially preferably from 100° C. to 115° C. The temperature is preferably at least 50° C., more particularly at least 60° C., very preferably at least 70° C., more particularly at least 80° C., especially preferably at least 90° C., more particularly at least 100° C., more particularly at least 110° C., exceptionally preferably at least 120° C., more particularly at least 130° C. Moreover, the temperature is preferably at most 180° C., more particularly at most 170° C., very preferably at most 160° C., more particularly at most 150° C.

The drying in step d) of the method sequence indicated above takes place preferably in at least two stages, with the temperature of drying being increased from one step to the next. In contrast to the situation when using high starting temperatures (e.g. 120° C.) for the drying, a staged increase in the drying temperature enables uniform drying, so leading to a uniform distribution of the cell sizes. At the lower temperature, there is first of all a relatively uniform preliminary drying of the foam as a whole, and, in the further step at the higher temperature, the residual moisture is removed.

It may, however, also be desirable to achieve a cell size which varies over the cross section. In that case, a high drying temperature ought to be used straight away. This ensures that the foam dries rapidly on the surface, but remains wet for a long time inside, thereby producing the different distribution in cell sizes over the cross section.

With particular preference the drying in step d) takes place in two stages, with the temperature of the drying in the 1^{st} step being from 50° C. to 100° C., preferably 70° C. to 90° C., more particularly 80° C., and the temperature of the drying in the 2^{nd} step being from 105° C. to 180° C., preferably 110° C. to 150° C., more particularly 120° C.

The resultant polyurethane foam substrate can be rolled up for storage, and cut up and dispensed in any desired size.

Preferred thicknesses of the polyurethane foam substrate are at least 0.1 mm, more particularly at least 0.2 mm. Furthermore, the thicknesses of the polyurethane foam substrate are preferably at most 0.5 mm, more particularly at most 0.4 mm, more preferably at most 0.3 mm.

After the drying and optional crosslinking, the optional film may be removed and the carrier may be removed from the polyurethane foam substrate. It can be rolled up. Alternatively, film and/or carrier may remain, for example, as release liners on the polyurethane foam substrate.

In a further preferred alternative, a liner may already be applied to the carrier to which, then, the polyurethane foam is applied, this foam being subsequently dried directly on the liner. After the drying and optional crosslinking, the liner is removed from the carrier and rolled up together with the polyurethane foam substrate. An optional possibility is for a release coating to have been applied between carrier and liner or between liner and foam—a silicone coating, for example. The liner may be permanent or a release liner.

In yet a further preferred embodiment, the foam is applied to a carrier. A film is placed over the foam when it enters the oven. After the drying or at least partial curing, the film forms a liner and is rolled up with the polyurethane foam substrate. A further liner may optionally be applied over the carrier. The liner may likewise remain on the product and be rolled up with it. Liners, therefore, may be applied to the foam layer as a release layer from the carrier layer, as a film per se, as release liners removed from the film, or in any desired combination of the aforesaid possibilities.

Preferred possible materials for the release liner include paper, polymer films or any desired combinations. The paper may be furnished on one side or, in particular, on both sides with an adhesive coating composition (also referred to as adhesive or anti-adhesive composition), so as to reduce the tendency of adhering products to adhere to these surfaces (active release function). Examples of polymers of the polymer films are polyolefins, polyesters, polyamides, polyvinyl chlorides, fluoropolymers, polyimides, or any desired combinations. Examples of polyolefins include polyethylenes, polypropylenes or any desired combinations. Examples of polyesters include poly(ethylene terephthalates) (PET). In other examples, the polymer film consists of aromatic polyesters or polyesteramides. Particular suitability is possessed by polyethylene terephthalate (PET). Further preferred film materials are low-density polyethylene (LDPE), high-density polyethylenes (HDPE), polypropylene or any desired combinations.

As adhesive coating compositions, also called release coating, it is possible to employ a multiplicity of different substances: waxes, fluorinated or partly fluorinated compounds, carbamate lacquers and particularly silicones and also various copolymers with silicone fractions. In recent years, silicones have become largely established as release materials in the sector of adhesive tape application, owing to their easy processing, low costs and broad profile of properties. Other possible liners which can be used are structured liners or liners with fillers or other particulate substances or particles in or on the surface, or liners consisting of or coated with other suitable release layers or coatings.

The resulting foam layer-liner product can be dispensed from the roll and cut into desired sizes and shapes.

With particular preference the polyurethane foam has an elongation at break (measured in a method based on DIN EN ISO 527-3) of at least 100%, more particularly at least 200%, preferably at least 300%, more particularly at least 400%, very preferably at least 500%, more particularly at least 700%, with further preference of at least 800%, especially preferably of at least 1000%.

With particular preference the polyurethane foam substrate, i.e. the polyurethane foam carrier, exhibits a resilience of more than 50%, more preferably of more than 70% and more particularly of more than 80%. This means that preferably the elastic component of the substrate is larger than the plastic component.

With particular preference the polyurethane foam, on loading in the thickness direction in the fourth cycle, consistently exhibits a compressive strength of 10 to 1000 kPa, preferably 50 to 500 kPa, especially preferably 100 to 400 kPa, in the range between 40% and 60%, more preferably in the range between 30% and 70%, and especially preferably in the range between 20% and 80%. Here the polyurethane foam, on discontinuation of the loading, reverts within 5 minutes to at least 70%, preferably at least to 80%, especially preferably to at least 90% of its original thickness. Within 12 hours after loading, the foam regains 90%, preferably 95%, especially preferably 100% of its original thickness.

The polyurethane foam contains cells. These cells may be closed, half-open or open. At least 50% of the cells may have a cell diameter of at least approximately 30 μm, more particularly at least 40 μm, preferably at least 50 μm, more preferably at least 60 μm, more particularly at least 70 μm, very preferably at least 80 μm, more particularly at least 90 μm, especially suitably at least 100 μm, more particularly at least 120 μm, and preferably not greater than approximately 160 μm. In other preferred embodiments, at least 50% of cells have a cell diameter of not more than approximately 160 μm, more particularly not more than 140 μm, preferably not more than 120 μm, more particularly not more than 100 μm, very preferably not more than 90 μm, more particularly not more than 80 μm, particularly suitably not more than 70 μm, more particularly not more than 60 μm.

The flame-retarded polyurethane foam substrate of the invention is suitable in particular as a carrier for flame-retarded adhesive tapes. The present invention therefore further relates to an adhesive tape comprising at least one carrier composed of a polyurethane foam of the invention, and also at least one layer of a flame-retarded adhesive composition.

The adhesive composition is preferably a pressure-sensitive adhesive composition (PSA) and with further preference is based on an acrylate (co)polymer, silicone (co)polymer, natural rubber, nitrile rubber, i.e. acrylonitrile-butadiene rubber, or (optionally chemically or physically crosslinked) synthetic rubber such as vinylaromatic block copolymer, or a mixture thereof. Particularly preferred is an acrylate PSA. The (pressure-sensitive) adhesive composition may also comprise tackifier resin, in particular, for establishing an appropriate adhesion and/or an appropriate tack. The make-up and preparation of PSAs and PSA layers are part of the common knowledge of a person of ordinary skill in the art. In this regard, furthermore, reference may be made to the “Handbook of Pressure Sensitive Adhesive Technology”, third edition, edited by Donatas Satas, Satas & Associates, Warwick, R.I., US, 1999.

Frequently the PSA further comprises tackifier resin for adjusting the adhesion. Moreover, the PSA may have been crosslinked by means of UV, electron beams or other radiation, or thermally. Suitable processes based on UV polymerization are described, moreover, in DE 69214438 T2 or U.S. Pat. No. 7,491,434 B2.

An acrylate PSA, in other words a pressure-sensitive adhesive composition based on poly(meth)acrylates, is particularly preferred here for the adhesive tapes.

“Poly(meth)acrylates” are understood—in accordance with the general understanding—to be polymers which are accessible through radical polymerization of acrylic and/or methylacrylic monomers and also, optionally, further, copolymerizable monomers. In accordance with the invention the term “poly(meth)acrylate” embraces not only polymers based on acrylic acid and its derivatives but also those based on acrylic acid and methacrylic acid and their derivatives, and those based on methacrylic acid and its derivatives, with the polymers always comprising acrylic esters, methacrylic esters or mixtures of acrylic and methacrylic esters.

The polyacrylate is preferably obtainable by free or controlled radical polymerization of one or more (meth)acrylic acids or (meth)acrylic esters and with particular preference is crosslinked thermally in order—especially in the case of thick layers of adhesive composition—to prevent a crosslinking gradient which inevitably results from a photochemical crosslinking process or from electron-beam crosslinking.

One preferred variant uses thermally crosslinkable, poly(meth)acrylate-based polymers for the PSA. The composition advantageously comprises a polymer consisting of
(a1) 70 to 100 wt % of acrylic esters and/or methacrylic esters and/or the associated free acids, of the following structural formula

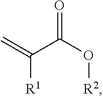

where R¹ represents H or CH₃ and R² represents H or alkyl chains having 1 to 14 carbon atoms;
(a2) 0 to 30 wt % of olefinically unsaturated monomers having functional groups; and
(a3) optionally further acrylates and/or methacrylates and/or olefinically unsaturated monomers (preferably with a fraction between 0 to 5 wt %) which are copolymerizable with component (a1) and have a functional group which by means of the coupling reagent leads to covalent crosslinking.

The weight figures are based on the polymer.

Preference for the monomers (a1) is given to using acrylic monomers comprising acrylic and methacrylic esters with alkyl groups consisting of 1 to 14 carbon atoms. Specific examples, without wishing to be confined by this enumeration, are methyl acrylate, methyl methacrylate, ethyl acrylate, ethyl methacrylate, propyl acrylate, propyl methacrylate, n-butyl acrylate, n-butyl methacrylate, n-pentyl acrylate, n-hexyl acrylate, n-hexyl methacrylate, n-heptyl acrylate, n-octyl acrylate, n-nonyl acrylate, lauryl acrylate, stearyl acrylate, stearyl methacrylate, behenyl acrylate, and branched isomers thereof such as 2-ethylhexyl acrylate, for example.

Further classes of compound for use that may likewise be added in small amounts under (a1) are cyclohexyl methacrylates, isobornyl acrylate and isobornyl methacrylates.

The fraction of these is preferably at most up to 20 wt %, more preferably at most up to 15 wt %, based in each case on the total amount of monomers (a1).

Preference for (a2) is given to using monomers such as, for example, maleic anhydride, itaconic anhydride, glycidyl methacrylate, benzyl acrylate, benzyl methacrylate, phenyl acrylate, phenyl methacrylate, tert-butylphenyl acrylate, tert-butylphenyl methacrylate, phenoxyethyl acrylate, phenoxyethyl methacrylate, 2-butoxyethyl methacrylate, 2-butoxyethyl acrylate, dimethylaminoethyl methacrylate, dimethylaminoethyl acrylate, diethylaminoethyl methacrylate, diethylaminoethyl acrylate and tetrahydrofurfuryl acrylate, this enumeration not being exhaustive.

Likewise used preferably for component (a2) are aromatic vinyl compounds, in which case the aromatic ring systems consist preferably of C₄ to C₁₈ building blocks and may also include heteroatoms. Particularly preferred examples are styrene, 4-vinylpyridine, N-vinylphthalimide, methylstyrene and 3,4-dimethoxystyrene, with this enumeration not being exhaustive.

Particularly preferred examples for component (a3) are hydroxyethyl acrylate, 3-hydroxypropyl acrylate, hydroxyethyl methacrylate, 3-hydroxypropyl methacrylate, 4-hydroxybutyl acrylate, 4-hydroxybutyl methacrylate, allyl alcohol, itaconic acid, acrylamide and cyanoethyl methacrylate, cyanoethyl acrylate, 6-hydroxyhexyl methacrylate, N-tert-butylacrylamide, N-methylolmethacrylamide, N-(butoxymethyl)methacrylamide, N-methylolacrylamide, N-(ethoxymethyl)acrylamide, N-isopropylacrylamide, vinylacetic acid, β-acryloyl-oxypropionic acid, trichloroacrylic acid, fumaric acid, crotonic acid, aconitic acid, dimethylacrylic acid and 4-vinylbenzoic acid, this enumeration not being exhaustive.

Monomers of component (a3) may also be selected advantageously in that they contain functional groups which support subsequent chemical radiation crosslinking (by electron beams or UV, for example). Suitable copolymerizable photoinitiators are, for example, benzoin acrylate and acrylate-functionalized benzophenone derivatives. Monomers which support crosslinking by electron beam bombardment are, for example, tetrahydrofurfuryl acrylate, N-tert-butylacrylamide and allyl acrylate, this enumeration not being exhaustive.

For the polymerization, the monomers are selected such that the resultant polymers can be employed as thermally crosslinkable polyacrylate compositions, more particularly in such a way that the resultant polymers possess properties of pressure-sensitive adherence in line with the “Handbook of Pressure Sensitive Adhesive Technology” by Donatas Satas (van Nostrand, N.Y., 1989).

Preferred flame retardants in the (pressure-sensitive) adhesive composition are as follows: (i) N-containing flame retardants, more particularly selected from the group consisting of melamine, triazine, isocyanurate, cyanuric acid, urea and guanidine; (ii) N/P-containing flame retardants, more particularly selected from the group consisting of hexaphenoxycyclotriphosphazene, (iii) P-containing flame retardants, more particularly selected from the group consisting of phosphines, phosphine oxides, phosphonium compounds, phosphonates, elemental red phosphorus and phosphites, phosphates such as ammonium polyphosphate, phosphinic salt and/or diphosphinic salt such as, for example, a metal phosphinate salt such as aluminium phosphinate salt or zinc phosphinate salt; (iv) halogen-containing flame retardants, (v) aluminium trihydrate or magnesium hydroxide. Preferably the fraction of flame retardant overall is 10 to 100 phr, more preferably 20 to 50 phr, and more particularly 30 to 35 phr, based on the base polymer. Particularly preferred are N/P-containing flame retardants. The fraction of flame retardant in total is also preferably 1 to 40 wt %, more preferably 10 to 35 wt % and more particularly 20 to 30 wt %, based on the pressure-sensitive adhesive composition.

The adhesive composition may comprise further fillers and/or additives. Further optional additives are pigments or dyes, stabilizers against effects of ageing and weathering, plasticizers, substances with fungistatic and bacteriostatic activity, fillers such as barium sulfate, bentonite, kaolin, glass powders, glass beads, glass fibres, calcium carbonate, kieselguhr, silica sand, fluoropolymers, thermoplastics, microspheres, expandable graphite, carbon black or precipitated chalk, or combinations thereof.

The polyurethane foam and also the adhesive tape of the present invention are suitable not only for double-sided adhesive tapes and diecuts, which are used in order to join two parts to one another, but also for single-sided adhesive tapes and diecuts. In the sense of this invention, the general expression “adhesive tape” (pressure-sensitive adhesive tape) embraces all sheetlike structures such as two-dimensionally extended films or film sections, tapes with extended length and limited width, tape sections and the like.

An adhesive tape has a lengthwise extent (x-direction) and a widthwise extent (y-direction). The adhesive tape also has a thickness (z-direction) which runs perpendicular to the two extents, with the widthwise extent and lengthwise extent being greater by a multiple than the thickness. The thickness is very nearly the same, preferably exactly the same, over the entire areal extent of the adhesive tape as defined by length and width.

In the context of the present invention, the inventors have recognized that the frothing (beating) of flame retarded polyurethane dispersions produces flame-retarded polyurethane foams which can be used as carriers of “backings” for adhesive tapes. Since the polyurethane dispersions are intrinsically flame-retarded, i.e. the polymer comprises a comonomer with flame retardancy effect that is incorporated within the polymer, the flame retardancy effect does not derive from added additives which could possibly migrate into a different layer or within the layer. The problems associated with the migration, especially the problem of nonuniform or inadequate flame retardancy effect, can therefore be reliably avoided by the present invention.

The polyurethane dispersions of the present invention are readily foamable and afford elastic foams having flame retardancy effect. In conjunction with flame-retarded acrylate PSAs, very good pressure-sensitive adhesive tapes having flame retardancy effect are obtained. Experiments have shown that even if a carrier has good flame retardancy effect, this is not necessarily the case for the combination of carrier and an acrylate PSA. In the case of the pressure-sensitive adhesive tapes of the invention, however, it has emerged that the combination of flame-retarded carrier with the acrylate PSA having flame retardancy effect, in other words the pressure-sensitive adhesive tape, also exhibits a good flame retardancy effect.

In contrast to the flame-retarded foams of the prior art, whose hardness and thickness make them unsuitable for use as carriers for adhesive tapes, the method of the invention, by mechanical beating (frothing), affords elastic foams with flame retardancy effect that are very highly suitable as carriers for flame-retarded adhesive tapes.

The adhesive tapes of the invention are therefore particularly suitable for use in the adhesive bonding of components in constructions which are subject to heightened safety requirements in relation to low flammability and/or flame retardancy. Accordingly they are particularly suitable for use in the transport sector, for example in aircraft, trains, buses, and also elevators, and also in motor vehicles in general. Furthermore, the adhesive tapes of the invention are especially suitable for use in computer technology, where, as a result of progressive miniaturization of components, the number of pressure-sensitive adhesive tapes being used is becoming ever greater, but at the same time the requirements imposed on them are also becoming ever more exacting. Even in operation, but also during fabrication, the circuits are subject to very high temperatures, which the adhesive tapes of the invention can cope with.

### EXPERIMENTAL SECTION

The following exemplary experiments are intended to elucidate the invention in more detail without subjecting the invention to any unnecessary restriction through the choice of the examples specified.

### Test Methods

The following test methods were employed for determining the parameters in the examples and also the preferred parameters specified in the description.

Unless otherwise indicated, all measurements were conducted at 23° C. and 50% relative humidity.

### Thickness

The thickness of a layer of adhesive composition, an adhesive tape or foam layer, a carrier layer or a liner can be determined using commercial thickness gauges (sensor instruments) having accuracies of less than 1 μm deviation. In the present specification, the gauge used is the Mod. 2000 F precision thickness gauge, which has a circular sensor with a diameter of 10 mm (plane). The measurement force is 4 N. The value is read off 1 s after loading. If fluctuations in thickness are found, the value reported is the average value of measurements at not less than three representative sites—in other words, in particular, not including measurement at wrinkles, creases, nibs and the like. The thickness of a layer of adhesive composition can be determined in particular by determining the thickness of a section of such a layer of adhesive composition, applied to a carrier or liner, said section being of defined length and defined width, with subtraction of the thickness of a section of the carrier or liner used that has the same dimensions (the thickness being known or separately ascertainable).

### Coat Weight (Areal Density)

The coat weight (areal density) of a sample such as, for example, an adhesive composition or a foam on a substrate such as, for example, a liner pertains, unless otherwise indicated, to the weight per unit area after drying. The coat weight may be determined by determining the mass of a section of such a sample applied to a substrate, the section being of defined length and defined width, minus the (known or separately ascertainable) mass of a section of the substrate used that has the same dimensions.

### Density

The density of a foam carrier is ascertained by forming the quotient of the coat weight and thickness of the foam applied to a substrate such as, for example, a liner.

### Solids Content

The solids content is a measure of the fraction of unevaporable constituents in a sample such as, for example, a dispersion. It is determined gravimetrically, by weighing the sample, then evaporating the evaporable fractions in a drying cabinet at 120° C. for 2 hours, and reweighing the residue.

### Viscosity

Dynamic viscosity measurement: The viscosity is measured using a rheometer of type ARES (Rheometric Scientific) at room temperature (20° C.) and at a shear rate of 100 s⁻¹ using a cone/plate system with a diameter of 50 mm.

### Elongation at Break (Breaking Stress)

The elongation at break (breaking stress) of a carrier is measured in a method based on DIN EN ISO 527-3 using a type 2 test specimen strip of the carrier having a width of 20 mm, at a separation velocity of 100 mm per minute. The initial spacing of the clamping jaws is 100 mm.

### Resilience or Elasticity

Resilience was measured by elongating by 100%, holding in this elongation for 30 s, and then releasing. After a waiting time of 1 min, the length was measured again. The resilience is calculated as follows: RV=((L₁₀₀−L_{end})/L₀)·100

where RV=resilience in %
L₁₀₀: length after elongation by 100%
L₀: length before elongation
L_{end}: length after relaxation for 1 min.

The resilience here corresponds to the elasticity.

### Compressive Strength

Test specimens of 30 mm×30 mm are cut from the material under test. These specimens are stacked with the edges in line to a height of 30 mm. The stack is placed in a stress-strain machine equipped with plates. With a velocity of 10 mm per minute, the plates are moved towards one another until the pre-tensioning force of 0.2 kPa has been reached. This point is set as the zero point of the compression. Subsequently, compression takes place at 50 mm per minute up to a compression of 80%. At this point a record is made of the force required per unit area (compressive strength). The machine is subsequently run back to 0% compression. Four cycles are recorded. The cycle critical for the assessment of the foam is the fourth cycle.

### Molecular Weight Mₙ

The figures for the number-average molecular weight Mₙ in this specification are based on the determination by gel permeation chromatography (GPC). The determination is made on 100 μl of a sample having undergone clarifying filtration (sample concentration 4 g/I). The eluent used is tetrahydrofuran with 0.1 vol % trifluoroacetic acid. Measurement takes place at 25° C. The precolumn used is a column of type PSS-SDV, 5 μm, 10³ Å, 8.0 mm*50 mm (figures here and below in the following order: type, particle size, porosity, internal diameter*length; 1 Å=10⁻¹⁰ m). Separation takes place using a combination of the columns of type PSS-SDV, 5 μm, 10³ Å and also 10⁵ Å and 10⁶ Å each with 8.0 mm*300 mm (columns from Polymer Standards Service; detection using Shodex RI71 differential refractometer). The flow rate is 1.0 ml per minute. Calibration takes place in the case of polar molecules such as, for example, the starting materials of the polyurethane against PMMA standards (polymethyl methacrylate calibration), and otherwise against PS standards (polystyrene calibration).

### Combustibility

The combustibility is tested in a method based on FAR 25.853. The test is carried out in a test chamber in which the specimen for testing is mounted vertically. The specimen for testing has a size of 75 mm×300 mm. The middle of the lower end of the specimen is exposed to a gas flame for an ignition time of 12 seconds. Measured thereafter are afterburn time, burn length and burn time of the droplets. Afterburn time is the time for which the sample burns after the ignition time. Burn length is the length of burnt material consumed by the end of the fire. Burn time of the drops is the time for which drops of the sample that fall off during burning continue to burn after dropping.

The combustibility test is passed if the afterburn time is not more than 15 seconds, the burn length not more than 203 mm and the burn time of the droplets not more than 3 seconds.

### Production and Properties of the Samples

### Raw Materials Used:

TABLE 1
Raw materials used

| | | |
|---|---|---|
| Permutex | aqueous dispersion of a phosphorus- | Stahl |
| RU-13-597 | containing polycarbonate/polyester | Holdings B.V. |
| | PU | |
| Hauthane | aqueous dispersion of an aliphatic | Hauthaway & Sons |
| L3808 | phosphorus-containing polyurethane | Corporation |
| Permutex | aqueous dispersion of an aliphatic | Stahl |
| RU-4049 | polyether PU | Holdings B.V. |
| Impranil | aqueous dispersion of an aliphatic | Covestro AG |
| DLU | polycarbonate/polyester PU | |
| Impranil | aqueous dispersion of an aliphatic | Covestro AG |
| DLE | polyether PU | |
| Ortegol | foam stabilizer - aqueous solution of | Evonik Nutrition |
| P2 | a nonionic surfactant | & Care GmbH |
| Stokal | foam stabilizer - aqueous solution of | Bozetto Group |
| STA | ammonium stearate | |
| Stokal | foam stabilizer - aqueous dispersion | Bozetto Group |
| SR | of succinamate | |
| Sultflon | foam stabilizer - aqueous solution of | Bozetto Group |
| SAF | a sodium salt of fatty acid alkyl | |
| | polyglycol ether sulfates | |
| Borchi | thickener - aqueous solution of an | Borchers |
| Gel ALA | anionic polymer | |
| Ortegol | thickener - aqueous solution of a | Evonik Nutrition |
| PV301 | nonionic associative PU-based | & Care GmbH |
| | thickener with approximately | |
| | newtonian behaviour | |
| Imprafix | crosslinker - aqueous solution of a | Covestro AG |
| 2794 XP | blocked aliphatic isocyanate | |

### Formulations of the Foamed Carriers:

TABLE 2
Compositions of the inventive and comparative examples

| | Inventive | Inventive | | Inventive | | Inventive | | Comparative |
|---|---|---|---|---|---|---|---|---|
| Component | Example 1 | Example 2 | | Example 3 | | Example 4 | | Example 5 |
| Permutex RU-13-597 | 100 g | 50 | g | 50 | g | 50 | g | — |
| Permutex RU-4049 | — | 50 | g | — | | — | | — |
| Impranil DLU | — | — | | 50 | g | — | | 100 g |
| Impranil DLE | — | — | | — | | 50 | g | — |
| Ortegol P2 | 6 g | 12 | g | 12 | g | 12 | g | 6 g |
| Imprafix 2794XP | 6 g | 6 | g | 6 | g | 6 | g | 6 g |
| (optional) | | | | | | | | |
| Ortegol PV301 | 2 g | 4 | g | 4 | g | 4 | g | 2 g |
| Water | 2 g | 2 | g | 2 | g | 2 | g | 2 g |

TABLE 3
Compositions of the inventive examples

| | Inventive | Inventive |
|---|---|---|
| Component | Example 6 | Example 7 |
| Hauthane L-3808 | 100 g | 68 g |
| Permutex RU-13-597 | | |
| Impranil DLU | | 32 g |
| Stokal STA | 2 g | 2 g |
| Stokal SR | 2 g | 2 g |
| Sultaflon SAF | 2 g | 2 g |
| Imprafix 2794 XP | 6 g | 6 g |
| (optional) | | |

### Production of the Beaten Foams:

The polyurethane (PU) dispersions (Permutex and/or Impranil) and the foam stabilizer (Ortegol P2 or a mixture of types of Stokel) are mixed in a beaker using a paddle stirrer (300 s at 500 rpm). Optionally it is possible additionally to add a crosslinker such as Imprafix 2794. The mixture is subsequently beaten with a paddle stirrer at 2000 rpm until there is no further increase in the volume of the beaten foam. Ortegol PV301 or Borchi Gel ALA is diluted with water beforehand and added to the beaten foam in portions with stirring at 500 rpm. This is followed by further homogenization for 300 s.

Flame-retarded polyurethane dispersions can be foamed neat (Inventive Examples 1 and 6, Inventive Example 6 preferred). To increase foam quality or to set desired mechanical properties, they can also be blended with other, non-flame-retarded dispersions such as Permutex RU-4049, Impranil DLU and Impranil DLE (Inventive Examples 2-4 and 8, Inventive Example 8 preferred) or blended with other flame-retarded polyurethane dispersions (Inventive Example 7). Blending with other aqueous polymer dispersions (such as acrylates, natural rubber and synthetic rubber) is likewise conceivable. Optionally a crosslinker such as Imprafix 2794 can be added in order to increase the mechanical and chemical resistance of the foam. Specified as Example 5 for comparison is a dispersion which is not flame-retarded (prior art).

### Production of the Foamed Carriers:

The beaten foam is coated in each case onto a siliconized polyester carrier (“Silphan S50” from the manufacturer Siliconature SPA) (wet film thickness 500-1000 μm) and cured for 60 s each at 80° C., 105° C. and optionally at 150° C. After 24 h, the foamed carrier can be removed from the liner.

### Properties of the Foamed Carriers:

TABLE 4
Properties of the foamed carrier

| | Inventive | | Inventive | | Inventive | | Inventive | | Comparative | |
|---|---|---|---|---|---|---|---|---|---|---|
| | Example 1 | | Example 2 | | Example 3 | | Example 4 | | Example 5 | |
| Afterburn time | 0 | s | 0 | s | 0 | s | 0 | s | 20 | s |
| Burn length | 60 | mm | 35 | mm | 45 | mm | 60 | mm | 300 | mm |
| Burn time of drops | 0 | s | 0 | s | 0 | s | 0 | s | 0 | s |
| Thickness | 140 | μm | 300 | μm | 300 | μm | 300 | μm | 300 | μm |
| Density | 370 | g/l | 350 | g/l | 410 | g/l | 460 | g/l | 300 | g/l |

TABLE 5
Properties of the foamed carrier.

| | |
|---|---|
| Inventive | Inventive |
| Example 6 | Example 7 |

| | | | | |
|---|---|---|---|---|
| Afterburn time | 0 | s | 1 | s |
| Burn length | 50 | mm | 50 | mm |
| Burn time of drops | 0 | s | 1 | s |
| Thickness | 532 | μm | 671 | μm |
| Density | 254 | g/l | 216 | g/l |

The foamed carriers of Inventive Examples 1 to 4 and 6 to 7, the polyurethane in which has been produced from comonomers including a comonomer having a flame retardancy effect, pass the combustibility test, whereas the foamed carrier from Comparative Example 5, without a flame retardant, does not.

The foamed carriers of Inventive Examples 2 and 4, moreover, have an elongation at break of at least 700%. The foamed carriers of Inventive Examples 6 and 7 can be compressed to 20% of their original thickness. Inventive Example 7 here has a compressive strength of 80 kPa at 50% compression and 860 kPa at 80% compression in the 4th compression cycle, and also a resilience of 80% within a few minutes and 95% within 12 hours. In contrast to this, Inventive Example 6 exhibits a compressive strength of 3.68 MPa at 80% compression in the 4th cycle and a resilience of 40% within a few minutes and 57% within 12 h. Consequently it is not possible to report a compressive strength at 50% compression in the 4th cycle.

The foamed carriers from Inventive Examples 2 to 4, moreover, have lower cell diameters than the foamed carrier from Inventive Example 1.

### Production of Flame-Retarded Foam-Backed Adhesive Tapes:

The foamed carrier is laminated on either side with 50 g/m² of flame-retarded pressure-sensitive adhesive composition. The flame-retarded PSA is a polyacrylate PSA comprising N/P-containing flame retardant.

Properties of the Pressure-Sensitive Adhesive Tapes with Foamed Carrier:

TABLE 6
Properties of the pressure-sensitive adhesive tapes
composed of foamed carrier and polyacrylate PSA

| | Inventive | | Inventive | | Inventive | | Inventive | | Comparative | |
|---|---|---|---|---|---|---|---|---|---|---|
| | Example 1 | | Example 2 | | Example 3 | | Example 4 | | Example 5 | |
| Afterburn | 0 | s | 0 | s | 0 | s | 0 | s | 20 | s |
| time | | | | | | | | | | |
| Burn | 75 | mm | 5 | mm | 35 | mm | 30 | mm | 300 | mm |
| length | | | | | | | | | | |
| Burn time | 0 | s | 0 | s | 0 | s | 0 | s | 0 | s |
| of drops | | | | | | | | | | |

The foam-backed adhesive tapes of Inventive Examples 1 to 4 pass the combustibility test, whereas the foam-backed adhesive tape from Comparative Example 5 does not.

1. A polyurethane foam obtainable by mechanical foaming of a starting mixture comprising a polyurethane dispersion, the polyurethane being composed of:
at least one polyisocyanate component;
at least one polyol component; and
at least one surfactant,
wherein the polyol component or at least one of the polyol components comprises at least one comonomer having flame retardancy effect and containing two hydroxyl groups.

2. The polyurethane foam of claim 1, wherein the polyurethane foam has an elongation at break of at least 100%.

3. The polyurethane foam of claim 1, wherein the polyurethane foam, on loading in the thickness direction in the fourth cycle in the range from 20% to 80% compression, consistently exhibits a compressive strength of 50 to 500 kPa, and the polyurethane foam, after the loading has been discontinued, reverts to at least 80% of its original thickness.

4. The polyurethane foam of claim 1, wherein the at least one surfactant is a nonionic surfactant, an ionic surfactant, or a combination thereof.

5. The polyurethane foam of claim 1, wherein the at least one comonomer having flame retardancy effect is a halogen-containing comonomer selected from the group consisting of derivatives of tetrabromophthalic acid, modified 2,3-dibromo-2-butene-1,4-diols, tris(2-chloroisopropyl) phosphate, tetrabromobisphenol A, and mixtures thereof.

6. The polyurethane foam of claim 1, wherein the at least one comonomer having flame retardancy effect is a phosphorus-containing comonomer selected from the group consisting of hydroxyl-functionalized alkyl phosphates such as, in particular, hydroxyl-functionalized tributyl phosphate, hydroxyl-functionalized triphenyl phosphate, hydroxyl-functionalized triethyl phosphate, hydroxyl-functionalized diphenyl cresyl phosphate, hydroxyl-functionalized tris(2-chloroisopropyl) phosphate, a phosphate ester of the general formula
HO—(POOR₁—O—R₂—O)ₙ—POOR₁—OH
where R₁=alkyl or alkoxy, R₂=alkyl radical with C₁ to C₆, and 2≤n≤300, and mixtures thereof.

7. The polyurethane foam of claim 1, wherein the at least one polyisocyanate component is a diisocyanate.

8. The polyurethane foam of claim 1, wherein the at least one polyol component is selected from the group consisting of a diol, a polyether diol, a polyester diol, a polycarbonate diol, a polycaprolactone polyol, propanediol, butanediol, pentanediol, hexanediol, cyclohexanediol, cyclohexyldimethanol, octanediol, neopentyl glycol, diethylene glycol, triethylene glycol, trimethylpentanediol, benzenedimethanol, benzenediol, methylbenzenediol, bisphenol A, poly(butanediol-co-adipate) glycol, poly(hexanediol-co-adipate) glycol, poly(ethanediol-co-adipate) glycol, polytetramethylene glycol, polypropylene glycol, polyethylene glycol, and a mixture thereof.

9. The polyurethane foam of claim 1, wherein the starting mixture further comprises a thickener.

10. The polyurethane foam of claim 1, wherein the starting mixture further comprises a crosslinker.

11. The polyurethane foam of claim 1, wherein the starting mixture further comprises at least one further dispersion selected from the group consisting of polyurethane dispersions whose polyol component includes a comonomer having flame retardancy effect, polyurethane dispersions whose polyol component includes no comonomer having flame retardancy effect, synthetic rubber dispersions, natural rubber dispersions, polyacrylate dispersions, and a combination thereof.

12. The polyurethane foam of claim 1, wherein the polyol component has a number-average molecular weight of 60 to 50 000 g/mol.

13. An adhesive tape comprising:
at least one carrier comprising the polyurethane foam of claim 1;
at least one layer of a flame-retarded pressure-sensitive adhesive composition; and
a layer of a flame-retarded pressure-sensitive adhesive composition arranged on both sides of the adhesive tape.

14. The adhesive tape of claim 13, wherein the adhesive composition is an acrylate adhesive composition.

15. The adhesive tape of claim 13, further comprising:
an intermediate layer configured to compensate expansion of battery cells during charge or discharge.

16. A method comprising:
adhesively bonding components with the adhesive tape of claim 13, wherein at least one of the components is a vehicle component, an aircraft component, a train component, or an electronic device component.

17. A method for producing a polyurethane foam, the method comprising:
a) initially introducing a polyurethane dispersion, at least one polyol component, at least one surfactant, an optional polyol component, and an optional dispersions comprising polyurethane or polyacrylate to form a starting mixture, wherein the polyurethane dispersion is composed of at least one polyisocyanate component and the at least one polyol component comprises at least one comonomer having flame retardancy effect and containing two hydroxyl groups
b) mechanically foaming the starting mixture to form a wet polyurethane foam composition, optionally with one or more of the following additional components:
ii) crosslinkers;
iii) fillers; and/or
iv) further additives;
c) applying the wet polyurethane foam composition to a surface; and
d) drying the wet polyurethane foam composition to give the polyurethane foam.

18. The method according to claim 17, wherein the drying in d) takes place in at least two stages, with the temperature of drying being increased from one step to the next.

19. The method according to claim 18, wherein the drying in d) takes place in two stages, with the temperature of the drying in the 1^{st} step being from 70° C. to 100° C. and the temperature of the drying in the 2^{nd} step being from 105° C. to 140° C.
